(19) United States
(12) Patent Application Publication
(10) Pub. No.: US 2023/0339472 A1
(43) Pub. Date: Oct. 26, 2023

(54) SYSTEM AND METHOD FOR AUTONOMOUS DRIVING MODE TRANSITION CONTROL BASED ON DRIVER DETECTION

(71) Applicant: TuSimple, Inc., San Diego, CA (US)

(72) Inventor: John BELL, Irvine, CA (US)

(21) Appl. No.: 18/137,577

(22) Filed: Apr. 21, 2023

Related U.S. Application Data
(60) Provisional application No. 63/335,078, filed on Apr. 26, 2022.

(51) Int. Cl. B60W 30/182; B60W 60/00; B60W 40/08; B60W 50/029; B60W 50/02

(52) U.S. Cl. CPC B60W 30/182; B60W 60/005; B60W 60/0015; B60W 40/08; B60W 50/029; B60W 50/0205; B60W 2040/0809; B60W 2040/0881; B60W 2420/42; B60W 2420/54; B60W 2540/043; B60W 2540/221; B60W 2556/60; G06V 20/593

(57) ABSTRACT

A system and method for autonomous driving mode transition control based on driver detection is disclosed. A method of an example embodiment comprises: obtaining a status from a driver detection sensor in an autonomous vehicle; obtaining a current operational status of the autonomous vehicle and a current operational status of an autonomous driving system (ADS) within the autonomous vehicle; causing disengagement of the ADS in the autonomous vehicle upon detection of the presence of a driver in the autonomous vehicle and detection of a vehicle fault or ADS fault; and preventing disengagement of the ADS in the autonomous vehicle upon detection of the absence of a driver in the autonomous vehicle and detection of a vehicle fault or ADS fault.

### PRIORITY PATENT APPLICATION

This non-provisional patent application draws priority from U.S. provisional patent application Ser. No. 63/335,078; filed Apr. 26, 2022. This present non-provisional patent application draws priority from the referenced patent application. The entire disclosure of the referenced patent application is considered part of the disclosure of the present application and is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document: Copyright 2021-2023, TuSimple, Inc., All Rights Reserved.

### TECHNICAL FIELD

This patent document pertains generally to tools (systems, apparatuses, methodologies, computer program products, etc.) for autonomous driving systems, driver or occupant detection, and more particularly, but not by way of limitation, to a system and method for autonomous driving mode transition control based on driver detection.

### BACKGROUND

Some advanced driver assistance systems (ADAS) and autonomous driving systems (ADS) use a sensing system to monitor driver state when a vehicle is being driven autonomously or near autonomously (semi-autonomously). These systems need to monitor the driver to ensure that the driver state is appropriate for the driving mode. Examples include built-in steering and torque sensors to estimate driver input, steering wheel touch sensors to check for presence of a driver's hand on the steering wheel, and camera monitoring systems to visually detect the driver state for a hands-free driving mode.

However, each of these conventional sensing systems has limitations when used for transitioning from an automated driving mode to a manual driving mode. For example, if the transition was not the intent of the driver, then a safety hazard is created as the system would have relinquished control to a human driver who is not present or not ready to take over. Consider an application where built-in steering system torque and position sensors are used to detect driver input as a signal to override autonomous control and transition to manual control. If in this situation something other than the driver's hands were the source of steering input (e.g., the driver's knee contacted the steering wheel or a faulty sensor signaled a false positive indication), then the system could end up transitioning to a manual driving mode contrary to the operator's intent, thus creating a hazard. Moreover, these conventional sensing systems are expensive, difficult to install, and subject to failures.

### BRIEF DESCRIPTION OF THE DRAWINGS

The various embodiments are illustrated by way of example, and not by way of limitation, in the figures of the accompanying drawings in which:

FIG. 1 illustrates the components of an autonomous driving mode transition control system according to an example embodiment;

FIG. 2 is a logic flow diagram illustrating an example embodiment of a system for autonomous driving mode transition control based on driver detection; and

FIG. 3 is a process flow diagram illustrating an example embodiment of a method for autonomous driving mode transition control based on driver detection.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

A system and method for autonomous driving mode transition control based on driver detection are disclosed herein. When an autonomous vehicle is being operated by an autonomous driving system (ADS), it is imperative that the ADS remains engaged until it is absolutely certain that a human driver is in the vehicle and able to control the movement of the vehicle. The ADS as described herein can enable an autonomous vehicle to be operated completely autonomously, which means the ADS has the capacity to drive the autonomous vehicle with no human in the autonomous vehicle. However, in some cases, there may be a human occupant present in the autonomous vehicle while the ADS is active to monitor the operation of the ADS. When a human occupant is present in the autonomous vehicle, it is important to manage the transition of control of the autonomous vehicle, if the ADS should experience a fault condition. The various example embodiments disclosed herein address these ADS control transfer situations.

In general, the ADS of an example embodiment enables the autonomous vehicle to override native safety features of a vehicle that may be retrofitted with an autonomous driving system. For example, the ADS is typically not prevented from operating even if a seat belt latch sensor detects an unfastened seat belt. In fact, seat belt latch detection has proven to be a poor indicator of the presence or absence of a driver as the seat belt latch sensor is easily defeated. The goal is typically to ensure that vehicles built or retro-fitted with an autonomous driving system (ADS) keep the ADS engaged as long as the autonomous vehicle and the ADS is operating nominally. However, in the case of fault conditions with the vehicle or the ADS, an ADS control transition protocol as disclosed herein provides a safe and effective ADS disengagement enablement and prevention mechanism.

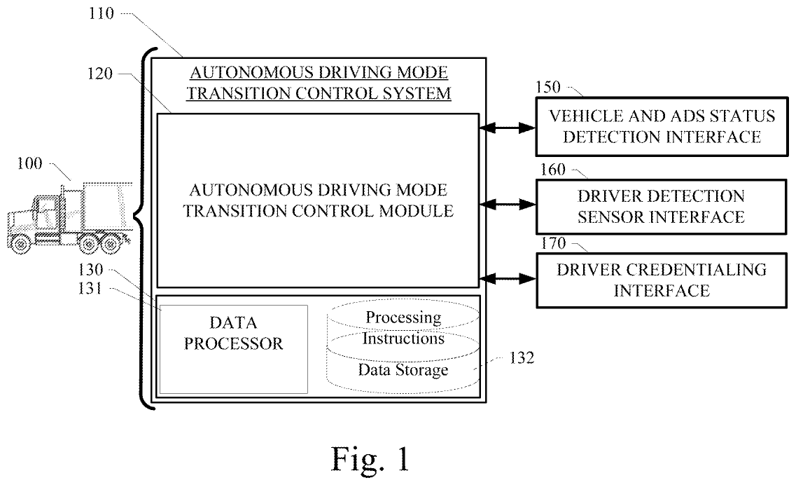

FIG. 1 illustrates the components of an autonomous driving mode transition control system according to an example embodiment. Referring to FIG. 1 for the example embodiment, an autonomous vehicle 100, such as a long haul truck, can be built or retro-fitted with an autonomous driving mode transition control system 110. The autonomous driving mode transition control system 110 can include an autonomous driving mode transition control module 120, which may comprise software or processing logic executable by a data processor 131 of a computing system 130. Computing system 130 may also include a data storage device 132 for retaining processing instructions and data for the autonomous driving mode transition control module 120.

The autonomous driving mode transition control system 110 may further include a data connection to a vehicle and ADS status detection interface 150 and a driver detection sensor interface 160. The vehicle and ADS status detection interface 150 represents one or more data signals from a vehicle control system, a vehicle sensor system, various vehicle components, and the like. Such vehicle control and sensor systems are well-known in conventional vehicle technology. These vehicle control and sensor system data signals can indicate whether a significant error or fault condition has been detected in the vehicle. Similarly, the vehicle and ADS status detection interface 150 represents one or more data signals from an ADS present and operating within an autonomous vehicle 100. The ADS data signals of the vehicle and ADS status detection interface 150 can indicate whether a significant error or fault condition has been detected in the ADS of autonomous vehicle 100. As described in more detail below, a significant error or fault condition detected in the autonomous vehicle 100 or the ADS of the autonomous vehicle 100 as communicated to the autonomous driving mode transition control module 120 via the vehicle and ADS status detection interface 150 can influence the ADS control transition protocol as disclosed herein.

Referring still to FIG. 1, the autonomous driving mode transition control system 110 may further include a data connection to a driver detection sensor interface 160. The driver detection sensor interface 160 represents one or more data signals from a driver detection sensor in the autonomous vehicle 100. In an example embodiment, the driver detection sensor can be a weight measuring device positioned under the driver seat to detect or measure weight applied to the seat when a human is sitting in the driver seat. If the driver detection sensor detects a weight level in excess of a pre-determined threshold, the driver detection sensor can signal a positive driver detection condition (e.g., driver present) via the driver detection sensor interface 160. If the driver detection sensor detects a weight level not in excess of a pre-determined threshold, the driver detection sensor can signal a negative driver detection condition (e.g., driver absent) via the driver detection sensor interface 160. In other example embodiments, the driver detection sensor can be a pressure sensing device, a body heat or thermal sensing device, an imaging device (e.g., camera) to visually detect the presence of a human driver, an acoustic device (e.g., microphone) to aurally detect the presence of a human driver, a CO2 emission detection device, or the like. For example, microphones can be installed in a cab or vehicle interior to detect sounds indicative of the presence of a driver in the driver seat. In another example, a pressure sensing device can sense a level of downward pressure or pressure change exerted by a person seated in the driver seat. In another example, a body heat or thermal sensing device can generate a thermal signature of a person seated in the driver seat. In another example, touch sensors in the steering wheel, feedback in the steering column, and/or feedback from pressure on the brake or accelerator pedals can be used to detect tactile sensations indicative of the presence of a driver in the driver seat or a driver intending to take control of the steering wheel. In another example, a camera and image analysis system can be installed in a cab or vehicle interior to capture images of a driver in the vehicle driver seat. The captured images can be processed by the image analysis system to determine if a person is in the driver seat and whether the posture or positioning of the person is indicative of the presence of a driver in the driver seat or a driver intending to take control of the vehicle. In other examples, combinations of the driver detection methods described above can be used to increase the accuracy of the driver detection status. In each case, the driver detection sensor can be configured to signal a positive (or negative) driver detection condition or status via the driver detection sensor interface 160. As described in more detail below, a positive (or negative) driver detection condition detected in the autonomous vehicle 100 as communicated to the autonomous driving mode transition control module 120 via the driver detection sensor interface 160 can influence the ADS control transition protocol as disclosed herein.

Referring still to FIG. 1, the autonomous driving mode transition control system 110 may further include a data connection to a driver credentialing interface 170. The driver credentialing interface 170 represents one or more data signals from a driver credentialing system in or associated with the autonomous vehicle 100. The driver credentialing system can be used to validate the presence of a person in the autonomous vehicle and to validate the authority of the person to be present in the particular autonomous vehicle at a particular time and in a particular location. For example, the driver credentialing system can be configured with an interface external at the vehicle, which enables a person to present credentials to the driver credentialing system via the external interaface. The credentials can be in any of a variety of forms including, a key, fob, card, fingerprint, handprint, face scan, spoken password, or the like. The driver credentialing system can verify the presented credentials in a variety of ways. A driver can be allowed into the vehicle using the external interface after the person presents credentials and after verification of the credentials. The verification of the credentials may include matching the credentials against a database on the vehicle, matching the credentials against a remote database, matching/verification of the credentials by an authorized remote operator at a control center (e.g., human or remote data processor) at an oversight control center. The credentials may also be presented to the driver credentialing system through a mobile device (e.g., a phone or tablet) software application (app) or in the form of verification through an app on a hand-held device. Additionally, a verbal conversation between a person wishing to enter the autonomous vehicle and an authorized remote operator at a control center may occur through communication means on the autonomous vehicle or through an external device (e.g., calling on a phone or video app). The verbal conversation can be used to authenticate the person wishing to enter the autonomous vehicle and to enable the authorized remote operator to provide an authorization signal to the driver credentialing system to enable entry by the person into the autonomous vehicle.

Location verification, time, and status of the autonomous vehicle may also factor affecting whether or not a person/driver is allowed into an autonomous vehicle. Well-known Global Positioning System (GPS) receivers and other localization sensors may aid in determining the location of the autonomous vehicle. The location of the autonomous vehicle may also be overlaid on a map that includes locations where, under normal operations, a driver is expected to be allowed to enter the autonomous vehicle (e.g., at a launch/landing/docking area).

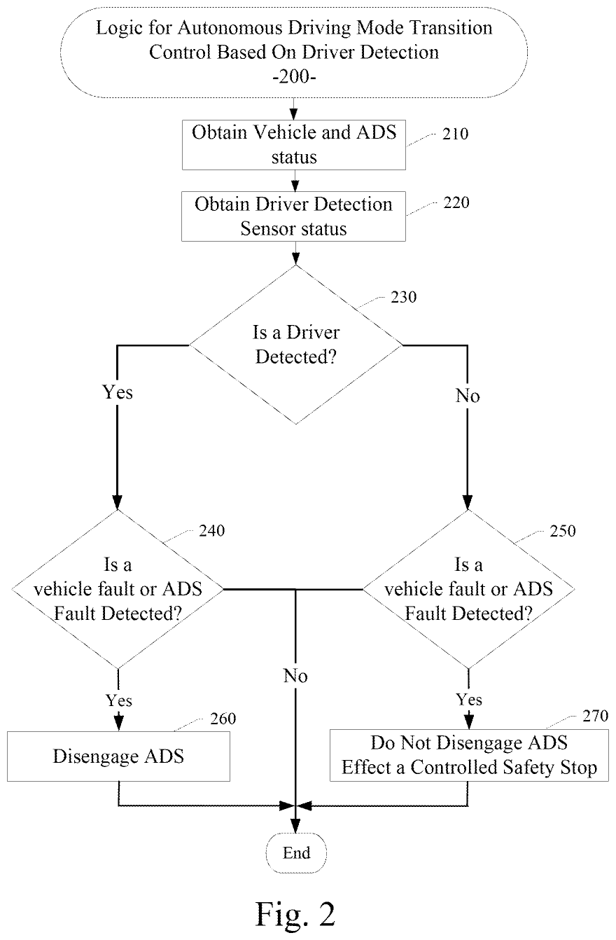

FIG. 2 is a logic flow diagram 200 illustrating an example embodiment of a system for autonomous driving mode transition control based on driver detection. Referring to FIG. 2 for the example embodiment, the autonomous driving mode transition control system 110 supports at least two modes of operation. Firstly, the autonomous driving mode transition control system 110 can be configured to detect the presence of a driver in the autonomous vehicle, which can cause the autonomous driving mode transition control system 110 to disengage the ADS on a vehicle fault or ADS fault. Secondly, the autonomous driving mode transition control system 110 can be configured to detect the absence of a driver in the autonomous vehicle, which can cause the autonomous driving mode transition control system 110 to suppress or prevent disengagement of the ADS on a vehicle fault or ADS fault. In this case, a safe mode of the ADS can guide the autonomous vehicle 100 to safe stop or direct the autonomous vehicle 100 to pull over to the side of the road. In general, example embodiments can be configured to match the ADS transition process or mode with driver detection status. The operational or processing logic 200 for an example embodiment of the system for autonomous driving mode transition control based on driver detection is illustrated in FIG. 2.

Referring still to FIG. 2, the autonomous driving mode transition control system 110 of an example embodiment may be configured to perform or execute the operational or processing logic 200 for autonomous driving mode transition control based on driver detection. In the example embodiment shown, the autonomous driving mode transition control system 110 can obtain a current operational status of the autonomous vehicle 100 and a current operational status of the ADS within the autonomous vehicle 100 (operation 210). As described above, the status of the vehicle and the ADS can include signals indicating whether a significant error or fault condition has been detected in the vehicle or ADS. Similarly, the autonomous driving mode transition control system 110 can obtain one or more data signals representing status from a driver detection sensor in the autonomous vehicle 100 (operation 220). As described above for an example embodiment, the driver detection sensor can determine if a weight level in excess of a pre-determined threshold is detected in the driver's seat. If so, the driver detection sensor can signal a positive driver detection condition (e.g., driver present), which is received by the autonomous driving mode transition control system 110 at block 220.

Once the vehicle and ADS status and driver detection sensor status are obtained in operations 210 and 220, the autonomous driving mode transition control system 110 can use the driver detection sensor status to determine if a human driver has been detected in the autonomous vehicle 100 (decision block 230). If a human driver has been detected in the autonomous vehicle 100, operational or processing control can be passed to decision block 240. If a human driver has not been detected in the autonomous vehicle 100, operational or processing control can be passed to decision block 250.

At decision block 240, a human driver has been detected in the autonomous vehicle 100. In this case, the autonomous driving mode transition control system 110 can use the current operational status of the autonomous vehicle 100 and the current operational status of the ADS within the autonomous vehicle 100 obtained in operation 210 to determine if an error or fault condition has been detected in the autonomous vehicle 100 or the ADS within the autonomous vehicle 100. If such a fault has been detected, operational or processing control can be passed to operation 260 where the ADS can be safely disengaged thereby allowing the driver to take manual control of the autonomous vehicle 100. If a fault at decision block 240 has not been detected, operational or processing control for the current iteration of the autonomous driving mode transition control system 110 can be returned or terminated. In this case, the autonomous vehicle 100 and the ADS within the autonomous vehicle 100 remain in a current state.

Referring still to FIG. 2 at decision block 250, a human driver has not been detected in the autonomous vehicle 100. In this case, the autonomous driving mode transition control system 110 can use the current operational status of the autonomous vehicle 100 and the current operational status of the ADS within the autonomous vehicle 100 obtained in operation 210 to determine if an error or fault condition has been detected in the autonomous vehicle 100 or the ADS within the autonomous vehicle 100. If such a fault has been detected, operational or processing control can be passed to operation 270 where disengagement of the ADS can be suppressed or prevented thereby allowing a safe mode of the ADS to guide the autonomous vehicle 100 to a safe stop or to direct the autonomous vehicle 100 to pull over to the side of the road. If a fault at decision block 250 has not been detected, operational or processing control for the current iteration of the autonomous driving mode transition control system 110 can be returned or terminated. In this case, the autonomous vehicle 100 and the ADS within the autonomous vehicle 100 remain in a current state. Thus, logic flow 200 illustrating an example embodiment of a system for autonomous driving mode transition control based on driver detection is described.

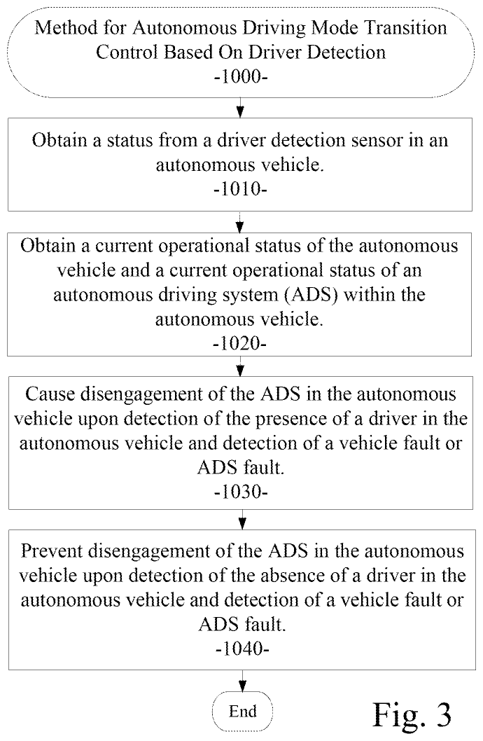

Referring now to FIG. 3, a process flow diagram illustrates an example embodiment of a method 1000 of an example embodiment for autonomous driving mode transition control based on driver detection. The example embodiment can include: obtaining a status from a driver detection sensor in an autonomous vehicle (processing block 1010); obtaining a current operational status of the autonomous vehicle and a current operational status of an autonomous driving system (ADS) within the autonomous vehicle (processing block 1020); causing disengagement of the ADS in the autonomous vehicle upon detection of the presence of a driver in the autonomous vehicle and detection of a vehicle fault or ADS fault (processing block 1030); and preventing disengagement of the ADS in the autonomous vehicle upon detection of the absence of a driver in the autonomous vehicle and detection of a vehicle fault or ADS fault (processing block 1040).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An autonomous driving mode transition control system comprising:
a data processor installed in an autonomous vehicle;
a driver detection sensor interface;
a vehicle and autonomous driving system (ADS) status detection interface; and
an autonomous driving mode transition control module executable by the data processor and in data communication with the driver detection sensor interface and the vehicle and ADS status detection interface, the autonomous driving mode transition control module configured to:
cause disengagement of an ADS in the autonomous vehicle upon detection of the presence of a driver in the autonomous vehicle and detection of a vehicle fault or an ADS fault; and
prevent disengagement of the ADS in the autonomous vehicle upon detection of the absence of a driver in the autonomous vehicle and detection of a vehicle fault or an ADS fault.

2. The system of claim 1 being further configured to cause the autonomous vehicle to effect a controlled safety stop upon detection of the absence of the driver in the autonomous vehicle and detection of the vehicle fault or the ADS fault.

3. The system of claim 1 wherein the driver detection sensor interface is configured to receive signals from a driver detection sensor, the driver detection sensor being configured to detect weight in a driver seat of the autonomous vehicle.

4. The system of claim 1 wherein the driver detection sensor interface is configured to receive signals from a driver detection sensor, the driver detection sensor being configured to detect a pressure change in a driver seat of the autonomous vehicle.

5. The system of claim 1 wherein the driver detection sensor interface is configured to receive signals from a driver detection sensor, the driver detection sensor being configured to detect a thermal signature of a person in a driver seat of the autonomous vehicle.

6. The system of claim 1 wherein the driver detection sensor interface is configured to receive signals from a driver detection sensor, the driver detection sensor being configured to visually detect a presence of a person in a driver seat of the autonomous vehicle.

7. The system of claim 1 wherein the driver detection sensor interface is configured to receive signals from a driver detection sensor, the driver detection sensor being configured to aurally detect a presence of a person in a driver seat of the autonomous vehicle.

8. The system of claim 1 wherein the driver detection sensor interface is configured to receive signals from a driver detection sensor, the driver detection sensor being configured to detect a CO2 emission of a person in a driver seat of the autonomous vehicle.

9. The system of claim 1 wherein the vehicle and ADS status detection interface being configured to receive status data signal from a vehicle subsystem of the autonomous vehicle.

10. The system of claim 1 wherein the vehicle and ADS status detection interface being configured to receive status data signal from the ADS of the autonomous vehicle.

11. A method comprising:
obtaining a status from a driver detection sensor in an autonomous vehicle;
obtaining a current operational status of the autonomous vehicle and a current operational status of an autonomous driving system (ADS) within the autonomous vehicle;
causing disengagement of the ADS in the autonomous vehicle upon detection of the presence of a driver in the autonomous vehicle and detection of a vehicle fault or ADS fault; and
preventing disengagement of the ADS in the autonomous vehicle upon detection of the absence of a driver in the autonomous vehicle and detection of a vehicle fault or ADS fault.

12. The method of claim 11 including causing the autonomous vehicle to effect a controlled safety stop upon detection of the absence of the driver in the autonomous vehicle and detection of the vehicle fault or ADS fault.

13. The method of claim 11 wherein the driver detection sensor is configured to detect one or more conditions selected from a group consisting of: weight of a person in a driver seat of the autonomous vehicle, pressure on a steering wheel or accelerator pedal, a thermal signature of a person in the driver seat of the autonomous vehicle, a visual detection of a person in the driver seat of the autonomous vehicle, an aural detection of a person in the autonomous vehicle, and a CO2 emission of a person in the driver seat of the autonomous vehicle.

14. The method of claim 11 including using a driver credentialing system to validate authority of a person to enter a particular autonomous vehicle at a particular time and in a particular location.

15. The method of claim 11 including enabling a driver credentialing system to accept credentials presented to the driver credentialing system via an external interface by a person requesting entry into the autonomous vehicle, and validating the presented credentials.

16. The method of claim 15 wherein the credentials are in a form selected from a group consisting of: a key, fob, card, fingerprint, handprint, face scan, spoken password, and a software application (app) on a mobile device.

17. The method of claim 11 including enabling a driver credentialing system to match credentials against a database, the database being resident in the autonomous vehicle or remotely located.

18. The method of claim 11 including enabling a driver credentialing system to accept credential validation from an authorized remote operator at a control center.

19. The method of claim 11 including using a driver credentialing system to validate credentials based on a location, time, and status of the autonomous vehicle.

20. The method of claim 19 wherein the location of the autonomous vehicle is determined by a Global Positioning System (GPS) receiver.
